(19) United States
(12) Patent Application Publication
(10) Pub. No.: US 2008/0237384 A1
(43) Pub. Date: Oct. 2, 2008

(54) Occupant size variable adaptive and progressive load limiting seat belt retractor

(75) Inventors: Thomas H. Zelmer, Auburn Hills, MI (US); Gunter K. Clute, Bloomfield Hills, MI (US)

Correspondence Address: AUTOLIV ASP, 3350 AIRORT ROAD, OGDEN, UT, 84405, US

(73) Assignee: Autoliv ASP, Inc.

(21) Appl. No.: 11/729,909

(22) Filed: Mar. 29, 2007

(51) Int. Cl. B60R 22/34

(52) U.S. Cl. 242/379.1

(57) ABSTRACT

A seat belt retractor providing adaptive load-limiting characteristics. The retractor incorporates a torsional load-limiting element in the retractor for providing torsional deflection of the webbing spool in response to restraint loads exerted by seat belt webbing. The seat belt webbing is chosen to have an enhanced thickness to provide a significant difference in torsion drive radius between conditions in which a small occupant uses the belt where a large number of wraps of webbing is stored on the spool as compared with a larger occupant using the belt in which a smaller number wraps of webbing are present on the spool. These differing conditions produce differences in spool drive radius and consequently greater torque is applied by the small occupant for given belt forces compare with the larger occupant. In this manner, the retractor provides belt webbing load-limiting which is self-adaptive between sizes of occupants without the requirement of retractor switching mechanisms.

### FIELD OF THE INVENTION

This invention relates to an automotive safety device and particularly to a seat belt retractor having adaptive load limiting characteristics.

### BACKGROUND OF THE INVENTION

Seat belt retractors are in wide spread use as part of a belt restraint system for occupants of motor vehicles. Retractor devices store seat belt webbing and maintain a relatively taught condition of the webbing when the seat belt is deployed for use by a motor vehicle occupant. Belt restraint systems have been shown to provide protection for occupants both in conditions of vehicle impacts, as well as rollover events. Seat belt retractors generally incorporate a locking device, such as an inertia sensitive types, which allows the retractor to freely pay-out webbing to provide comfort and convenience for the occupant and to adapt to the occupant's size. The emergency locking mechanism locks the seat belt retractor to restrict extraction of webbing during conditions where occupant restraint is required. In addition to inertia type “vehicle sensitive” locking systems, “webbing sensitive” devices lock the retractor when a high rate of belt extraction occurs, such as during a vehicle impact.

In a condition in which seat belt webbing is restraining an occupant and high forces are applied to the belt system, some level of seat belt webbing stretch and extraction from the retractor occurs as the system is subjected to crash loads. As a means of enhancing occupant protection, seat belt system manufacturers offer load-limiting features in seat belt retractors. These features allow a controlled rotational deflection of the seat belt retractor spool to occur in response to belt loads. These load-limiting features are designed to reduce the peak loads exerted by the belt webbing on the vehicle occupant when the retractor is locked. The design intent is to maintain belt loads on the occupant within human tolerance ranges, while absorbing energy for restraining the occupant. Load-limiting systems are typically in the form of a torsion bar within the seat belt retractor spool having carefully selected torsional deflection characteristics.

In a further effort to provide improvements in seat belt retractors, adaptive load-limiting systems are also offered by automotive restraint system manufacturers. In these systems, a control system is incorporated into a retractor in which either the accident severity or occupant type is typically evaluated, and a control system is operated within the retractor to provide two or more levels of load-limiting characteristics for the retractor. For example, a larger occupant, such as a so-called 95^{th} percentile male occupant, would require higher restraint loads as compared with a smaller occupant, such as a 5^{th} percentile female, in similar impact severity conditions. Adaptive load-limiting systems ordinarily incorporate a clutch or locking mechanism in the retractor which most typically allows either a first or second section of a torsion bar to be operative to provide load-limiting torsional deflection.

Although the adaptive load-limiting systems described previously provide benefits, they add cost and complexity to the restraint system. Automotive component manufacturers continuously strive to reduce cost, complexity, and weight of restraint systems, while providing high reliability. This invention is related to a seat belt retractor system design which provides adaptive load-limiting characteristics based on occupant size, while minimizing the complexity, size, and cost of the associated retractor mechanism.

### SUMMARY OF THE INVENTION

The load-limiting characteristics of a retractor are dependent upon the torsional stiffness of the load-liming elements, such as a torsion bar, and also the radial distance at which the seat belt webbing applies torque to the spool and the load-limiting element. The radial distance of application of force to the spool by webbing tension varies in conventional retractors to a limited degree depends upon the number of webbing wraps on the spool. Thus, when the majority of the webbing is wrapped on the spool, a larger radial distance is provided between the force applied by webbing tension and the center of rotation of the spool. Conversely, when a lesser number of wraps of webbing is on the spool, a smaller radial distance results. Since the load-limiting element's response is based on applied torque, and greater torque is produced when the webbing tension is exerted farther than the axis of spool rotation, differences occur in load-limiting behavior. This phenomenon, inherent with current retractors, thus provides a slightly different load-limiting characteristic as a function of the amount of webbing wrapped on the spool. The amount of webbing wrapped on the spool can be generally related to the size of the occupant, with larger occupants having less webbing wrapped on the spool when the system is latched, as compared with smaller occupants where more webbing is stored. Thus, slight differences in load-limiting characteristics are provided by presently available retractors based on the total thickness of webbing wrapped on the spool. However, this difference in load limiting force is not sufficient to provide meaningful adaptive load-limiting characteristics. This invention seeks to significantly magnify the previously noted adaptive characteristics based on the number of wraps of webbing on a retractor spool.

In accordance with the present invention, the seat belt webbing is intentionally selected to be thicker than conventional seat belt webbing, for example, in the range of 3 mm as compared with around 1 or 1.2 mm for presently used seat belt webbing. This greater thickness is not provided for enhancing tensile strength of the webbing, but rather to provide the previously noted effect of varying load-limiting behavior. With thicker seat belt webbing used, a greater change in radius occurs between the point of tension load application on the spool and the center of spool rotation. Thus, the smaller occupant with more of the thick webbing stowed on the retractor produces a large effective radius, thus producing more torque on the load-limiting element for a given applied webbing tension force. Conversely, the larger occupant, presumably heavier, leaves less of the thick webbing on the spool, providing a decreased torque on the load-limiting element for a given force level. This effect provides adaptive load-limiting characteristics without complex mechanisms.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is an exploded view of a seat belt retractor spool showing a load-limiting element and seat belt webbing attached to the spool;

FIG. 2 is a side view of a representative belt retractor mounted to a vehicle illustrating a condition in which a relatively large amount of thick webbing is wrapped on the spool corresponding to its use by a smaller sized occupant using this system;

FIG. 3 is a view similar to FIG. 2 except showing the retractor and spool condition in which a large amount of the webbing is removed from the spool corresponding to a larger occupant using the system;

FIG. 4 is a table illustrating changes in effective radius between various sized occupants for a thin webbing system corresponding with the prior art and the thick webbing system in accordance with the present invention; and

FIG. 5 is a graph showing the adaptive load-limiting characteristics the seat belt retractor of the present invention.

### DETAILED DESCRIPTION OF THE PRESENT INVENTION

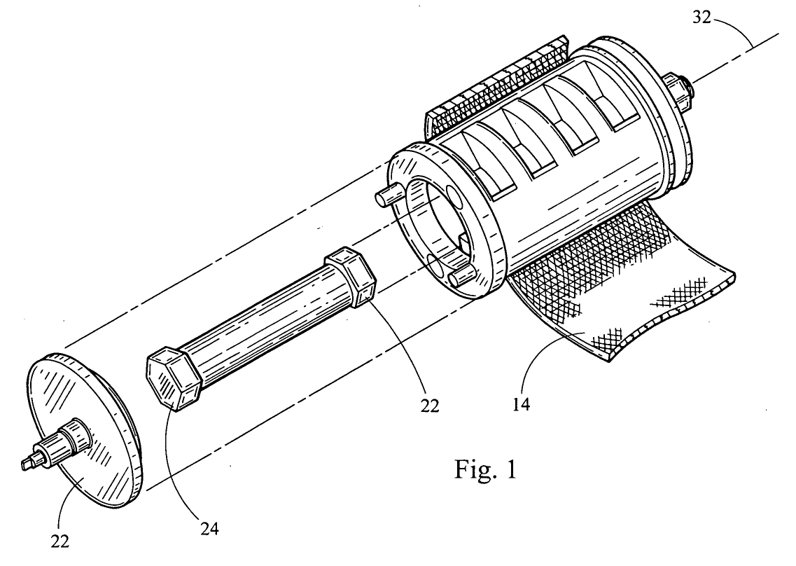

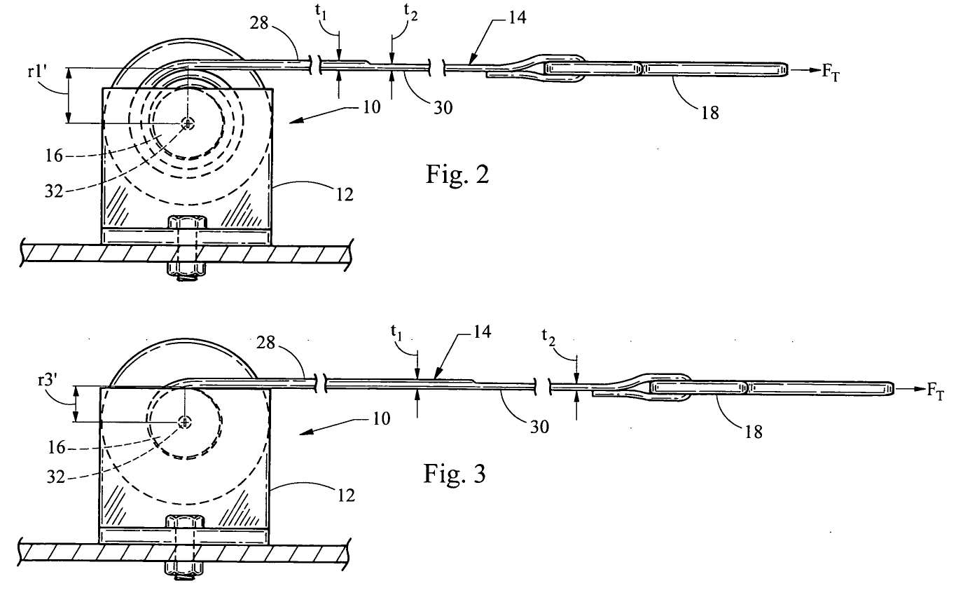

With particular reference to FIGS. 1, 2, and 3, a seat belt retractor in accordance with the present invention is illustrated which is generally designated by reference number 10. Seat belt retractor 10 includes a frame 12 enabling the retractor to be mounted to a fixed structure in a motor vehicle as illustrated in FIGS. 2 and 3. Seat belt webbing 14 is wrapped around and attached at one end to a rotatable spool 16 and is attached at its opposite end to a latch plate 18 or other fixation device for a motor vehicle seat belt restraint system.

FIG. 1 further illustrates the use of a load-limiting torsion bar 20 which is mounted inside the hollow interior of spool 16. Torsion bar 20 includes a pair of separated drive heads 22 and 24 at its ends. Drive head 22 engages with spool 16 whereas drive head 24 engages with a locking hub 26. In an associated retractor 10, a locking device (not shown) would be provided which would ground locking hub 26 to the retractor frame 26 in response to inertial loads or other condition calling for belt restraint. In such an event, tension forces (F_{T}) applied on webbing 14 cause a torsional load (T) acting on spool 16 which is restrained by torsional forces acting through torsion bar 20. By selecting the mechanical and material characteristics of torsion bar 20, a desired level of torsional deflection of the torsion bar can be provided which is related to load-limiting of the restraint force (F_{T}) acting on webbing 14.

Load-limiting retractors of the type generally described above are well-known in the art. An example of such a system is provided by the present Assignees' commonly owned U.S. Pat. Nos. 6,616,081 and 6,105,894 which are hereby incorporated by reference. These referenced patents describe locking mechanisms which provide engagement of the load-limiting element, such as torsion bar 20. Although torsion bar 20 is described herein, other forms of torsional load-limiting elements could be incorporated which are within the scope of the present invention. Load limiting devices in accordance with this invention provide a desired level of rotational deflection of spool 16 in response to an applied torque load (T) through tension (F_{T}) on webbing 14.

In accordance with a principal feature of the present invention webbing 14 differs from conventional seat belt webbing. Conventional seat belt webbing generally has a thickness of about 1.2 mm. That thickness is selected to provide acceptable tension and load distribution characteristics on the occupant. In accordance with the present invention, webbing 14 incorporates at least a section having a substantially greater thickness than is found in prior art retractors of this type. In the embodiments described herein, seat belt webbing 14 is formed with two sections defined as fixed end section 28 and extendible end section 30. Fixed end section 28 is fastened to spool 16, whereas extendible end section 30 forms the attachment with latch plate 18. As will be evident from the further description of the present invention, it is also within the scope of this invention to provide webbing 14 having a constant increased thickness to achieve the benefits of the present invention.

Webbing 14 illustrated in FIGS. 2 and 3 includes a fixed end webbing section 28 having a thickness designated as t₁, whereas the extendible end section 30 has a thickness designated as t₂. In preferred embodiments of the present invention, the thickness t₁ of fixed end section 28 is selected to be about 3.0 mm. This thickness (t₁) could be increased to the point where the bulk of the webbing becomes unacceptable which is believed to be at around 3.5 mm. The thickness (t₂) of extendible end section 30 can be selected on the order of conventional seat belt webbing which is generally as mentioned previously, about 1.2 mm. As also stated above, extendible end section 30 may have a thickness (t₂) equivalent to that of fixed end section 28.

With continued reference to FIGS. 2 and 3, spool axis 32 is designated which is the center of rotation about which spool 16 rotates during extension and retraction of webbing 14 and also during its load-limiting rotational deflection. The force designated as F_{T} is shown which identifies a tension load applied to seat belt webbing during an occupant restraint event. FIG. 2 illustrates the condition of retractor 10 when a relatively smaller occupant is using the system. In this illustrative condition, four or five layers of webbing fixed end section 28 are wrapped on spool 16. FIG. 3 illustrates the condition of retractor 10 when a relatively larger occupant is deploying the system in which a comparatively smaller number of wraps of webbing fixed end section 28 are on spool 16, there shown as two wraps or layers. In FIG. 2, a torque radius (r) of r1′ is created between F_{T} and spool axis 32, whereas in FIG. 3, a torque radius of r3′ is produced. The torque (T) applied to torsion bar 20 is expressed as F_{T}r=T. Thus, if r1′ is greater than r3′, the resulting torque (T) is greater for a given magnitude of F_{T}. The increased thickness (t₁) of webbing fixed end section 28 exaggerates the difference in effective torque (T) applied between the two conditions illustrated in FIGS. 2 and 3.

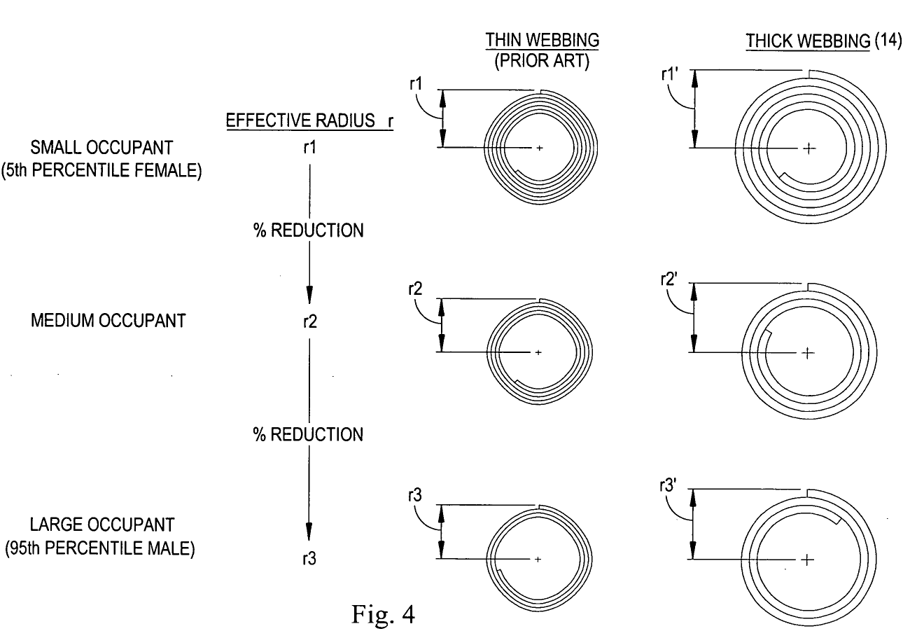

FIG. 4 illustrates a comparison in torque applied radius (r) for conditions where small, medium, and large occupants are using the system, illustrated both for the “thin webbing” of the prior art (corresponding to webbing thickness “t” of approximately 1.2 mm) and the “thick webbing” system of the present invention in which t₁ is about 3.0 mm. In both the thin and thick webbing conditions, varying amounts of webbing 14 are wrapped on spool 16 when small (5^{th} percentile female), medium, and large (95^{th} percentile male) occupants have deployed the restraint system. For the thin webbing prior art condition, the torque applying radius (r) varies from r1 to r3, going from small to large occupant. Similarly, the radius (r) varies from r1′ to r3′ for the thick webbing condition. In accordance with the present invention, the difference in radius (r) between the small and large occupant conditions is greater than that compared with the thin webbing. This can be stated as: r1′/r3′>r1/r3. In preferred embodiments of this invention, the ratio of r1′ and r3′ is desired to be on the order of more than a 10% difference when comparing a small occupant (5^{th} percentile female) to the large occupant (95^{th} percentile male) conditions.

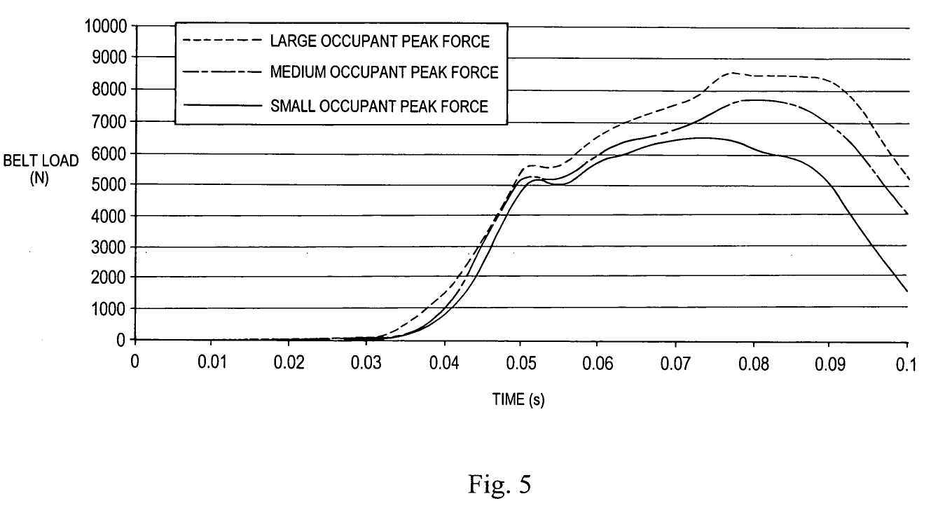

FIG. 5 illustrates the difference in belt load on a webbing 14 shown in the Y axis of the graph as it varies over time in a representative impact condition for various sized occupants using a retractor 10 having the features of the present invention. As illustrated, significant differences in belt forces F_{T} between the large and small occupants is produced. Thus, the system provides adaptive load-limiting characteristics without the need for complex clutch and other mechanisms in the retractor by utilizing a difference in drive radius through thick webbing 14 wrapped on the spool 16.

Various modifications of the present invention are fully within the scope of the present invention and would provide the benefits described previously. For example, it is not necessary for the entire width of webbing 14 to have an increased thickness. For example, the center portion of the webbing 14 could be made thicker or edge areas of the webbing made thicker rather than the entire width of the webbing having a constant thickness. In either case, the effective drive radius (r) would vary significantly with differing numbers of wraps on spool 16.

In the previously illustrated embodiment, a thickness of webbing 14 changed in stepwise manner (t₁ to t₂) between webbing end sections 28 and 30. However, a change in thickness could occur in multiple steps or in a continuous manner between these two sections. In a particular application of the present invention, the thick webbing provided at fixed end section 28 could be over a length which does not directly contact most occupants. For example, it could be a section normally present behind trim panels or otherwise extending between the retractor and a typical occupant.

While the above description constitutes the preferred embodiments of the present invention, it will be appreciated that the invention is susceptible to modification, variation and change without departing from the proper scope and fair meaning of the accompanying claims.

1. A load-limiting vehicle seat belt retractor for a motor vehicle seat belt restraint system for retraining an occupant, comprising,
a retractor frame adapted to be mounted to the vehicle,
a retractor spool mounted to the frame for rotation,
belt webbing wrapped upon the spool for allowing extraction of the webbing from the spool and retraction of the webbing onto the spool during use of the seat belt restraint system, the seat belt webbing attached at a fixed end section to the spool and having an extendable end section coupled to a latching element of the restraint system,
a retractor locking mechanism for locking the spool to restrict rotation of the spool relative to the frame and thereby limiting extraction of the webbing for restraining the occupant,
a load limiting element coupled to the spool such that upon the locking of the spool, the load limiting element is capable of torsional deflection to control restraint forces acting on the occupant exerted by the webbing, and
the seat belt webbing fixed end section having a thickness of about 3.0 mm, layers of the thick section wrapped upon the spool defining a first radius of force producing a first torque load on the load limiting element in a first condition of a large amount of the fixed end section wrapped on the spool, and the layers of the fixed end section defining a second radius in a second condition of a smaller amount of the fixed end section wrapped on the spool, the difference in the first and the second radii providing a greater torsional deflection of the load limiting element for a given tension force (F_{T}) on the webbing in the second condition as compared to the first condition.

2. A load-limiting vehicle seat belt retractor according to claim 1 further comprising, the thick section having a thickness of less than 3.5 mm.

3. A load-limiting vehicle seat belt retractor according to claim 1 further comprising, the seat belt webbing extendible end section having a thickness of about 1.2 mm.

4. A load-limiting vehicle seat belt retractor according to claim 1 further comprising, the ratio of thickness of the fixed end section to the extendible end section being more than 2:1.

5. A load-limiting vehicle seat belt retractor according to claim 1 further comprising the first condition corresponding to a condition in which a first smaller occupant is using the restraint system and the second condition corresponding to a condition in which a second larger occupant is using the restraint system whereby the seat belt retractor provides varying load limiting for the first and second occupants based on the amount to the webbing fixed end section wrapped on the spool.

6. A load-limiting vehicle seat belt retractor according to claim 1 wherein the thickness of the fixed end section and extendible end section being substantially equal.

7. A load-limiting vehicle seat belt retractor for a motor vehicle seat belt restraint system for retraining an occupant, comprising,
a retractor frame adapted to be mounted to the vehicle,
a retractor spool mounted to the frame for rotation,
belt webbing wrapped upon the spool for allowing extraction of the webbing from the spool and retraction of the webbing onto the spool during use of the seat belt restraint system, the seat belt webbing attached at a fixed end section to the spool and having an extendable end section coupled to a latching element of the restraint system,
a retractor locking mechanism for locking the spool to restrict rotation of the spool relative to the frame and thereby limiting extraction of the webbing for restraining the occupant,
a load limiting element coupled to the spool such that upon the locking of the spool, the load limiting element is capable of torsional deflection to control restraint forces acting on the occupant exerted by the webbing, and
the seat belt webbing fixed end section having, layers wrapped upon the spool defining a first radius of force producing a first torque load on the load limiting element in a first condition of a large amount of the fixed end section wrapped on the spool corresponding to a 5^{th} percentile female occupant using the restraint system, and the layers of the fixed end section defining a second radius in a second condition of a smaller amount of the fixed end section wrapped on the spool corresponding to a 95^{th} percentile male occupant using the restraint system, the difference in the first and the second radii providing a greater torsional deflection of the load limiting element for a given tension force (F_{T}) on the webbing in the second condition as compared to the first condition, the ratio of the first to the second radius being greater than 10%.

8. A load-limiting vehicle seat belt retractor according to claim 7 further comprising, the fixed end section having a thickness of about 3.0 mm.

9. A load-limiting vehicle seat belt retractor according to claim 7 further comprising, the fixed end section having a thickness of less than 3.5 mm

10. A load-limiting vehicle seat belt retractor according to claim 7 further comprising, the seat belt webbing extendible end section having a thickness of about 1.2 mm.

11. A load-limiting vehicle seat belt retractor according to claim 7 further comprising, the ratio of thickness of the fixed end section to the extendible end section being more than 2:1.

12. A load-limiting vehicle seat belt retractor according to claim 7 wherein the thickness of the fixed end section and extendible end section being substantially equal.
